(19) United States
(12) Patent Application Publication
(10) Pub. No.: US 2026/0356553 A1
(43) Pub. Date: Nov. 12, 2026

(54) CONTAINER CLOSURE WITH SEALING ELEMENT

(71) Applicant: ACTEGA DS GMBH, Bremen (DE)

(72) Inventors: Dany Mängel, Twistringen (DE); Mattias Kern, Lilienthal (DE)

(21) Appl. No.: 19/153,479

(22) PCT Filed: Feb. 7, 2023
(86) PCT No.: PCT/EP2023/052900

§ 371 Date: Aug. 4, 2025

(51) Int. Cl. B65D 53/02; C08L 23/0807; C08L 23/14

(52) U.S. Cl. CPC B65D 53/02; C08L 23/0815; C08L 23/14; C08L 2205/02; C08L 2207/062; C08L 2207/066

(57) ABSTRACT

(EN) The invention relates to a vessel closure with a sealing element. The sealing element comprises a polymer composition. The polymer composition comprises a butene copolymer. The butene copolymer exhibits a melting temperature Tm above 130 °C, wherein the melting temperature Tm is determined by the second heating curve of a DSC measurement at a heating rate of 10 °C min-1.

The invention relates to a sealing element from a polymer composition in a vessel closure, wherein the sealing element comprises or consists of a polymer compound containing at least one butene copolymer. More particularly, the sealing element does not comprise PVC.

Such sealing elements are known, for example, from WO 2020/021348.

The prior art on which this document is based is set out at the beginning of the description of the document. The entire disclosure of WO 2020 021348 is also made the subject matter of this patent application by reference.

These known sealing elements are said to have the advantage of very low migration values, which would mean that there is hardly any material migration between the seal and the filling material.

However, this known technology is limited to such butene copolymers, which have a maximum melting temperature (Tm) of 130 °C.

This is unfavourable, not least because several of the butene copolymers available on the market have melting points above 130 °C.

Seals comprising butene copolymers are known from EP 2 631 721 and EP 3 302 918. Apparently, however, these seals can only be produced with special formulations comprising both very specific butene copolymers and very specific polypropylene-based copolymers.

One objective of the invention is to provide a polymer composition based on butene copolymers which can be used as a sealing element in a vessel closure, which can be produced at acceptable cost using commercially available materials and which has very low migration values.

To solve these and other objectives, the sealing element or the vessel closure comprising it is provided with the feature combinations of the independent claims.

Advantageous embodiments of the invention are defined in the dependent claims.

General information on the vessel closures on which the invention is also based can be found in the aforementioned publication WO 2020 021348, in particular on p. 2.

According to the invention, such seals are used which comprise at least one butene copolymer with a melting temperature above 130 °C.

In contrast to the teaching of WO 2020 021348, it has been found that not only the use of a butene copolymer with a melting temperature Tm between 80 °C and 130 °C in a polymer composition of a sealing element of a vessel closure enables the production of vessel closures with excellent properties.

In fact, such vessel closures can also be produced with butene copolymers of which the melting point is above 130 °C, which also makes a majority of commercially available butene copolymers available for such seals.

The butene of the butene copolymer is preferably a 1-butene.

A comonomer of the butene copolymer can be propylene, so that the butene copolymer is a butene-propylene copolymer.

The butene copolymer can be a bipolymer, so that the butene copolymer has exactly one further comonomer, e.g. propylene, in addition to butene.

The butene copolymer may be present in the polymer composition in a proportion of between 0.1 wt. % and 80 wt. %. The butene copolymer may also be present in the polymer composition in a proportion of between 5 wt. % and 60 wt. %. Preferably, the proportion of the butene copolymer is between 8 wt. % and 55 wt. % in the polymer composition.

Weight percent data with reference to the polymer composition refer to the proportion of the respective component relative to the total weight of all components in the polymer composition.

The polymer composition may comprise a further butene copolymer. This further butene copolymer is a different type of polymer than the butene copolymer already described. The butene copolymer already described and the further butene copolymer in the polymer composition may differ in their physical properties (e.g. density, melting temperature, hardness, etc.). The butene copolymers may also differ in their structure (block copolymer, random copolymers, etc.).

The butene copolymers can also differ in the type of their comonomers (ethylene, propylene, etc.).

The butene in the further butene copolymer can be a 1-butene. Ethylene can be a comonomer of the further butene copolymer.

The copolymerised butene proportion of the further butene copolymer can be at least 60 mol %, in particular at least 80 mol %.

The further butene copolymer can be a butene bipolymer, so that the butene bipolymer has exactly one further type of comonomer in addition to the butene.

The further butene copolymer may be present in the polymer composition in a proportion of between 10 wt. % and 80 wt. %. Preferably, the further butene copolymer is present in the polymer composition in a proportion of between 22 wt. % and 70 wt. %. Specifically, the polymer composition contains between 40 wt. % and 65 wt. % of the further butene copolymer, based on the total weight of the polymer composition.

The polymer composition may comprise a polyethylene.

The polyethylene can be a homo-polyethylene. In particular, the homo-polyethylene can be an LDPE (low density polyethylene) or an HDPE (high density polyethylene).

The polyethylene may comprise between 5 wt. % and 60 wt. % of the polymer composition. Preferably, the proportion of polyethylene in the polymer composition is between 10 wt. % and 45 wt. %. In particular, the polyethylene is present in the polymer composition between 15 wt. % and 25 wt. %.

The polymer composition may comprise a random propylene copolymer.

The random propylene copolymer may have ethylene as a comonomer. In particular, the random propylene copolymer is a bipolymer.

Preferably, the polymer composition contains a random propylene-ethylene copolymer.

The random propylene copolymer can account for between 5 wt. % and 60 wt. % in the polymer composition. In particular, the proportion of the random propylene copolymer is between 10 wt. % and 45 wt. %. Particularly preferably, the proportion of the random propylene copolymer is between 15 wt. % and 35 wt. % in the polymer composition.

The polymer composition may also comprise a butene homopolymer, specifically between 5 wt. % and 35 wt. % of the polymer composition.

The butene of the butene homopolymer is specifically a 1-butene.

In particular, the butene homopolymer is present in the polymer composition between 10 wt. % and 45 wt. %. In particular, the proportion of the butene homopolymer in the polymer composition is between 15 wt. % and 35 wt. %.

The polymer composition may also comprise a copolymer, wherein preferably styrene is a comonomer of the copolymer.

In particular, the copolymer comprising styrene as a comonomer is an SBS, SEPS, SEEPS or SEBS. Particularly preferably, the copolymer comprising styrene as a comonomer is a SEBS.

The styrene-containing copolymer may be present in the polymer composition between 10 wt. % and 70 wt. %. Preferably, the proportion of the styrene-containing copolymer is between 20 wt. % and 60 wt. % in the polymer composition. The styrene-containing copolymer may also be present in the polymer composition between 35 wt. % and 55 wt. %.

The butene copolymer, in particular the butene-propylene copolymer, can be present in the polymer composition in a proportion of at least 80 wt. %. At least 90 wt. % of the butene copolymer may also be contained in the polymer composition. In this case, the butene copolymer, in particular the butene-propylene copolymer, may be the only polymeric component of the polymer composition and the polymer composition may contain only additives in addition to the butene copolymer.

Due to the advantageous composition of the polymer compositions, a high proportion of components that are liquid at 20 °C and 1000 hPa can be avoided. An example of such a component which is liquid at 20 °C and 1000 hPa is white oil. Therefore, the polymer composition preferably comprises a maximum of 10 wt. % of a component which is liquid at 20 °C and 1000 hPa. Specifically, the polymer composition comprises a maximum of 5 wt. % of such a component. In particular, the polymer composition (within the scope of the analytical possibilities on the date of filing) even comprises no such components.

The polymer composition may be a polyolefin composition. Accordingly, the polymer composition comprises only polyolefins as polymeric components. Additives may be present in the polymer composition even if they are not polyolefins and the polymer composition is a polyolefin composition.

Preferably, the polymer composition does not contain PVC (polyvinyl chloride).

It is preferred that the polymer composition does not contain an oxygen scavenger.

The polymer composition can be designed in such a way that it has a static coefficient of friction of maximum 0.50, preferably maximum 0.40. The coefficient of friction is determined in accordance with DIN EN ISO 8295. The coefficient of friction is adjusted by adding standard additives.

A low coefficient of friction is often difficult to reach, in particular with a low proportion of components that are liquid at 20 °C and 1000 hPa.

The polymer composition typically comprises additives. Preferably, the polymer composition comprises a maximum of 15 wt. % of additives. Specifically, the polymer composition comprises a maximum of 8 wt. % of additives. Particularly preferably, the polymer composition contains a maximum of 6 wt. % of additives.

Additives used can be selected from the group: pigments, nucleating agents, brighteners, stabilisers, surfactants, lubricants, antioxidants or combinations thereof.

The polymer composition may comprise between 43 wt. % and 57 wt. % of the butene copolymer and between 43 wt. % and 57 wt. % of the further butene copolymer.

The polymer composition specifically comprises between 8 wt. % and 16 wt. % of the butene copolymer, between 55 wt. % and 65 wt. % of the further butene copolymer and between 18 wt. % and 30 wt. % of the homo-polyethylene (in particular LDPE or HDPE).

Preferably, the polymer composition comprises between 8 wt. % and 16 wt. % of the butene copolymer, between 55 wt. % and 65 wt. % of the further butene copolymer and between 18 wt. % and 30 wt. % of the random propylene copolymer.

Specifically, the polymer composition comprises between 8 wt. % and 16 wt. % of the butene copolymer, between 55 wt. % and 65 wt. % of the further butene copolymer and between 18 wt. % and 30 wt. % of the butene homopolymer.

The polymer composition may comprise between 8 wt. % and 16 wt. % of the butene copolymer, between 55 wt. % and 65 wt. % of the further butene copolymer, between 3 wt. % and 12 wt. % of the homo-polyethylene (in particular LDPE) and between 10 wt. % and 22 wt. % of the random propylene copolymer.

The vessel closure can be a vacuum screw cap. Preferably, the vessel closure is a twist-off cam closure. The vessel closure can also be a press-on twist-off vessel closure or a composite closure.

Preferably, the polymer composition exhibits an oxygen permeability rate of less than 500 cm³ m² d⁻¹ bar⁻¹ at 1 mm film thickness and 23 °C, determined according to DIN 53380. A low oxygen permeability rate of the polymer composition results in a low entry of oxygen into a vessel which is closed with one of the described vessel closures. This ensures a longer shelf life of a filling product in a filled and sealed vessel.

The total migration of the polymer composition can be a maximum of 1.2 mg cm 2, preferably a maximum of 1.0 mg cm 2, particularly preferably a maximum of 0.8 mg cm 2, wherein the total migration of the polymer composition can be determined according to DIN-EN 1186-14.

A disclosed vessel closure can close a vessel. The vessel comprises a vessel mouth and a sealable opening at the end of the vessel mouth. This opening is closed by one of the disclosed vessel closures.

The vessel can be a glass vessel, plastic vessel or metal vessel. In particular, the vessel is a glass vessel.

A vacuum is preferably present in the closed vessel.

The opening of the vessel can have a diameter of at least 20 mm. In particular, the diameter of the opening of the vessel is a maximum of 120 mm.

During the process, the closed and filled vessel can be thermally treated. The temperature of the thermal treatment is above the temperature of the (solid and/or liquid) foodstuff during the filling of the vessel with it.

Thermal treatment can be carried out at a temperature of at least 60 °C.

The thermal treatment can also be carried out at a maximum temperature of 135 °C (between 60 °C and 135 °C). In particular, the thermal treatment takes place at a temperature of up to 135 °C (between 60 °C and 135 °C) at an absolute ambient pressure of a maximum of 4.0 bar, preferably at an absolute ambient pressure of between 1.0 bar and 4.0 bar.

Preferably, the pressure in the sealed vessel during thermal treatment is lower than the pressure outside the sealed vessel.

### EXAMPLES

Examples of polymer compositions for sealing elements in a vessel closure are shown in Tables 1 and 2.

TABLE 1

| | Example 1 | Example 2 | Example 3 | Example 4 |
|---|---|---|---|---|
| Component | | | | |
| Butene-propylene | 94.9 | 47.5 | 12.0 | 12.0 |
| copolymer, wt. % | | | | |
| Butene-ethylene | | 47.4 | 59.9 | 59.9 |
| copolymer, wt. % | | | | |
| LDPE, wt. % | | | 23.0 | |
| HDPE, wt. % | | | | 23.0 |
| Random | | | | |
| propylene-ethylene | | | | |
| copolymer, wt. % | | | | |
| Homo-polybutylene, | | | | |
| wt. % | | | | |
| Additives, wt. % | 5.1 | 5.1 | 5.1 | 5.1 |
| Properties | | | | |
| Coefficient of friction, | 0.32 | 0.26 | 0.23 | 0.17 |
| dimensionless | | | | |
| Total migration, mg cm⁻² | 0.56 | 0.79 | 0.88 | 0.83 |

TABLE 2

| | Example 5 | Example 6 | Example 7 |
|---|---|---|---|
| Component | | | |
| Butene-propylene | 12.0 | 12.0 | 12.0 |
| copolymer, wt. % | | | |
| Butene-ethylene | 59.9 | 59.9 | 59.9 |
| copolymer, wt. % | | | |
| LDPE, wt. % | | | 7.0 |
| HDPE, wt. % | | | |
| Random | 23.0 | | 16.0 |
| propylene-ethylene | | | |
| copolymer, wt. % | | | |
| Homo-polybutylene, | | 23.0 | |
| wt. % | | | |
| Additives, wt. % | 5.1 | 5.1 | 5.1 |
| Properties | | | |
| Coefficient of friction, | 0.19 | 0.20 | 0.17 |
| dimensionless | | | |
| Total migration, mg cm⁻² | 1.05 | 0.81 | 0.96 |

A typical value of the oxygen transmission rate of PVC-containing compositions used as a sealing element in vessel closures is approximately 220 cm³ m⁻² d⁻¹ bar⁻¹ at 23 °C.

The oxygen permeability rates of known, commercially available PVC-free compositions in vessel closures are typically 650 cm³ nr2 d 1 bar1 and more. Oxygen scavengers are often added to these known compositions to reduce the presence of oxygen in a vessel sealed with such a vessel closure.

The PVC-free polymer compositions disclosed herein exhibit oxygen permeability rates that are close to the rates of PVC-containing compositions. The oxygen permeability rates of the composition disclosed herein are significantly below the oxygen permeability rates of known PVC-free compositions.

A polymer composition with a low oxygen permeability rate avoids the use of oxygen scavenger materials in the polymer composition and at the same time ensures low oxygen ingress into the filled vessel.

The butene-propylene copolymer is commercially available.

The butene-ethylene copolymer used is available from LyondellBasell, for example. The copolymerised butene proportion can be at least 80 mol %.

LDPE and HDPE are commercially available from various suppliers.

The random propylene-ethylene copolymer can be purchased from Borealis.

Homo-polybutene is available from LyondellBasell.

SEBS is available from Kraton, for example from the Kraton G series.

1. A vessel closure with a sealing element, wherein
(a) the sealing element comprises a polymer composition; and
(b) the polymer composition comprises a first butene copolymer, wherein the butene copolymer has a melting temperature Tm above 130 °C, wherein the melting temperature Tm is determined by the second heating curve of a DSC measurement at a heating rate of 10 °C min 1.

2. The vessel closure according to claim 1, wherein the butene of the first butene copolymer is a 1-butene.

3. The vessel closure according to claim 1, wherein propylene is a comonomer of the first butene copolymer.

4. The vessel closure according to claim 1, wherein the first butene copolymer is a bipolymer.

5. The vessel closure according to claim 1, wherein the first butene copolymer is contained in the polymer composition in an amount between 8 wt. % and 55 wt. %.

6. The vessel closure according to claim 1, wherein the polymer composition comprises a second butene copolymer, wherein the first and second butene copolymers are different polymer types.

7. The vessel closure according to claim 6, wherein a comonomer of the second butene copolymer is ethylene.

8. The vessel closure according to claim 6, wherein the second butene copolymer is a butene bipolymer.

9. The vessel closure according to claim 6, wherein the second butene copolymer is contained in the polymer composition in an amount between 40 wt. % and 65 wt. %.

10. The vessel closure according to claim 1, wherein the polymer composition comprises a polyethylene, and wherein the polyethylene is contained in the polymer composition in an amount between 15 wt. % and 35 wt. %.

11. The vessel closure according to claim 10, wherein the polyethylene is an LDPE or an HDPE.

12. (canceled)

13. The vessel closure according to claim 1, wherein the polymer composition comprises a random propylene copolymer, wherein ethylene is a comonomer of the random propylene copolymer, and wherein the random propylene copolymer is present in the polymer composition in an amount between 15 wt. % and 35 wt. %.

14. (canceled)

15. The vessel closure according to claim 13, wherein the random propylene copolymer is a bipolymer.

16. (canceled)

17. The vessel closure according to claim 1, wherein the polymer composition comprises a butene homopolymer, and wherein the butene homopolymer is contained in the polymer composition in an amount between 15 wt. % and 35 wt. %.

18. (canceled)

19. The vessel closure according to claim 1, wherein the polymer composition contains SEBS, wherein the SEBS is contained in the polymer composition in an amount between 35 wt. % and 55 wt. %.

20-24. (canceled)

25. The vessel closure according to claim 1, wherein the polymer composition comprises a maximum of 10 wt. % of homo-polypropylene.

26. The vessel closure according claim 1, wherein the polymer composition comprises a maximum of 5 wt. %, of a component which is liquid at 20 °C and 1000 hPa.

27-32. (canceled)

33. The vessel closure according to claim 1, wherein the polymer composition has an oxygen permeability rate determined according to DIN 5BB80, of less than 400 cm³·m²·d·bar; wherein the polymer composition has a total migration, determined according to DIN-EN 1186-14, of maximum 0.8 mg·cm²

34-35. (canceled)

36. A vessel with a vessel mouth and a closable opening at the end of the vessel mouth, wherein the opening is closed with a vessel closure according claim 1.

37-38. (canceled)
